(19) United States
(12) Patent Application Publication
(10) Pub. No.: US 2003/0042150 A1
(43) Pub. Date: Mar. 6, 2003

(54) Electrochemical biosensor test strip with recognition electrode and readout meter using this test strip

(76) Inventors: Jun-Oh Ryu, Seoul (KR); Jin-Woo Lee, Kyunggi-Do (KR); In-Hwan Choi, Kyunggi-Do (KR)

Correspondence Address: THOMAS P O'CONNELL, 135 CAMBRIDGE STREET SUITE 10, BURLINGTON, MA, 01803

(21) Appl. No.: 10/239,469

(22) PCT Filed: Jan. 27, 2001
(86) PCT No.: PCT/KR01/00113

(30) Foreign Application Priority Data
Mar. 22, 2000 (KR) 2000/0014421

(51) Int. Cl. G01N 27/327

(52) U.S. Cl. 205/778; 204/403.01

(57) ABSTRACT

An Electrochemical biosensor system which can do selectively quantitative analysis of blood sugar, cholesterol and other elements in blood is disclosed. The electrochemical biosensor test strip used in this invention is provided with recognition electrode which indicates that a fixed reagent is used for what material's quantitative analysis. The readout meter used in this invention discriminates the use of inserted test strip by auto-recognition of the location of said recognition electrode and performs predetermined algorithm. According to this invention, it has advantage that various blood elements such as blood sugar, cholesterol, GOT and GPT can be analyzed quantitatively by one readout meter.

### TECHNICAL FIELD

The present invention relates to an electrochemical biosensor test strip which can operate selectively quantitative analysis on specific biomaterials such as blood sugar, cholesterol and so forth and an electrochemical biosensor readout meter using this test strip.

### BACKGROUND ART

Recently electrochemical biosensors are frequently used in medical field to analyze biomaterials including blood. Among those, enzyme-utilizing electrochemical biosensors are used most generally in hospitals and clinical labs because they are easy to apply, superior in measurement sensitivity, and allow rapid acquisition of test results. Enzyme analyzing method applied in electrochemical biosensors can be largely divided into chromophoric method which is a spectroscopic way and electrode method, an electrochemical way. Generally, the measuring time in chromophoric method takes longer than electrode method, and difficult to analyze significant biomaterials due to the measurement errors caused by the turbidity of biomaterials. Therefore, an electrode method is extensively applied in electrochemical biosensors recently. According to the method, in an electrode system established by screen printing, the quantitative measurement of a material of interest can be achieved by fixing a reagent onto the electrodes, introducing a sample, and applying an electric potential across the electrodes.

U.S. Pat. No. 5,437,999, “Electrochemical Sensor”, discloses an electrochemical biosensor test strip with a precisely defined electrode field applying technologies generally used in PCB industries adequately to an electrochemical biosensor test strip. This electrochemical biosensor test strip can operate analysis very precisely with a small amount of samples.

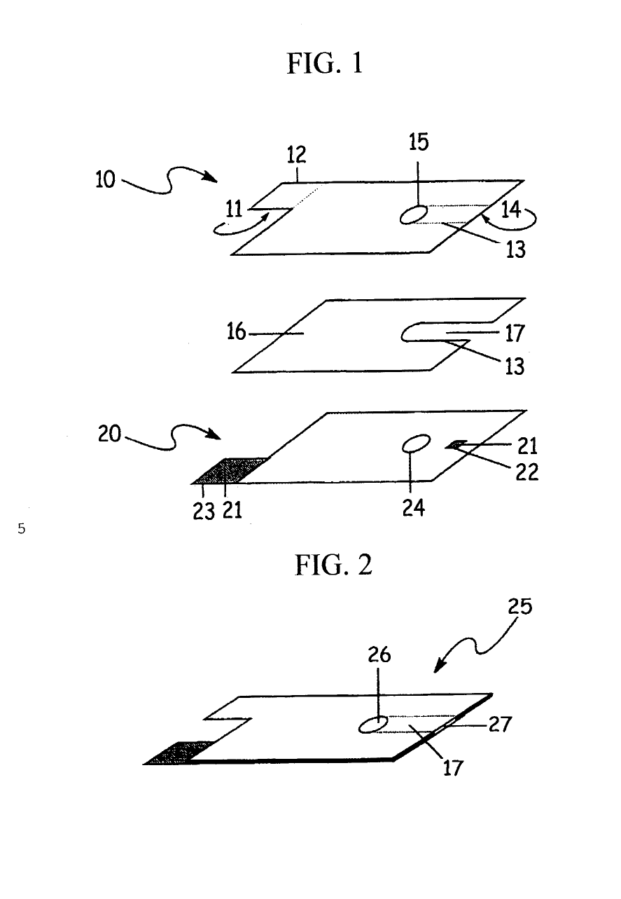

FIG. 1 is a disassembled perspective view of the opposing electrode type from the electrochemical biosensor test strip of the said U.S. patent and FIG. 2 shows the assembled state of the test strip of FIG. 1. As shown in the figure, the test strip comprises two electrodes: one is called a working electrode on which reactions occur and the other is called a reference electrode or a subsidiary electrode.

To disclose the components in detail referring to FIG. 1 and FIG. 2, an insulating substrate on which a reference electrode is formed, that is, a reference electrode element 10, is spatially detached from a working electrode element 20, an insulating substrate on which a working electrode is formed, by a spacer 16. Generally the spacer 16 is attached to the reference electrode element 10 during manufacturing process, but is illustrated separately from the reference electrode element 10 in FIG. 1. A first cutout portion 13 in the spacer 16 forms a capillary space 17 when placed between the reference electrode element 10 and the working electrode element 20. A first cutout portion 22 in the working electrode element 20 exposes a working electrode area and this working electrode area 21 is exposed to the capillary space 17. The first cutout portion 13 in the spacer 16 defines a reference electrode area 14, shown in dotted line in FIG. 1 when it is attached to the reference electrode element 10 and also this reference electrode area 14 is exposed to the capillary space 17. Second cutout portions 12, 23 expose a reference electrode area 11 and a working electrode area 21 respectively, and also serve as contact pads connecting a electrochemical biosensor test strip 25 to a biosensor measuring instrument(or a meter and a power source).

In an assembled state as shown in FIG. 2, the electrochemical biosensor test strip 25 has a first opening 27 on its one side. Also a vent port 24 in the working electrode element 20 and a vent port 15 in the reference electrode element 10 correspond and form a second opening 26. In use, a sample containing the material to be analyzed can be introduced into the capillary space 17 through the opening 26 or 27. In this case, the sample is spontaneously drawn into the electrochemical biosensor test strip by capillary action. As a result, the electrochemical biosensor test strip automatically controls the volume of sample to measure without the user's intervention.

This electrochemical biosensor test strip can operate very accurate electrochemical measurement, besides the advantage of requiring small amount of the sample, it has the advantage of separating the chemicals relevant to the working electrode or the reference electrode because it divides the two electrodes' manufacturing process.

But the conventional electrochemical biosensor measuring systems only could measure one material in each device and required the user's extreme caution to acquire the accurate results from various materials by one device. Therefore, the manufacturers of a biosensor readout meter had to focus greatly on producing process to eliminate malfunctioning in using the readout meter.

European Pat. No. 0471986 relates to an blood sugar measurement system using a disposable test strip, disclosing about the strip which discriminates whether blood is inserted to the test strip by measuring the electric resistance between a pair of electrodes and also accomplishes the various operations such as measurement mode modification by attaching a strip-shaped resistance to the test strip, or correcting the measurements of the readout meter etc.

U.S. Pat. No. 4,999,582 discloses a circuit which put on the reacting voltage to each end of the test strip after distinguishing whether the test strip is inserted into the biosensor readout meter.

U.S. Pat. No. 5,438,271 describes a circuit distinguishing whether a strip is properly inserted into the biosensor readout meter and discriminating whether the inserted strip is a test strip or a correction strip.

Preexisting biosensor readout meters could not analyze the different materials with one biosensor readout meter because they only have the function to distinguish whether the strip is inserted and to discriminate whether the inserted strip is a test strip or a correction strip.

### DISCLOSURE OF THE INVENTION

An object of the present invention is to provide an electrochemical biosensor strip which can automatically make the readout meter recognize what material the fixed reagent on the test strip is to detect.

Also, this invention provides a biosensor readout meter which can operate quantitative analysis on various materials selectively depending on the test strip.

In addition, this invention provides a correction test strip used for automatic correction of a readout meter to measure the electric current flowing in the test strip accurately as analyzing material's concentration through reactions between the material to be analyzed and the reagent.

To achieve the above-mentioned objectives, the first distinction of the electrochemical biosensor test strip of this invention is the recognition electrode, established at the fixed position of the test strip to indicate the material which the reagent fixed on the test strip is to analyze(hereinafter referred to ‘analyte’).

Also, the second distinction of the biosensor readout meter of this invention is that the quantitative analysis of the analytes is feasible by distinguishing the analyte on the test strip after automatically detecting the position of the recognition electrode depending on the insertion of the test strip and executing selectively the appropriate algorithm for this analyte.

Also, the third distinction of the biosensor readout meter according to this invention is a socket device comprising an electric connection device of which the connecting terminal is formed on the PCB by pattern, and an compressing device which establish the electric connection between the electrode of the test strip and the connecting terminal of the electric connection device by compressing the test strip to the electric connection device.

In addition, the electrochemical biosensor readout meter according to this invention is a readout meter using the electrochemical biosensor test strip from the first distinction above-mentioned, comprising a detection device detecting the recognition electrode, a working voltage generating circuit which applies the working voltage to the working electrode, a voltage conversion device which converts the electric current flowing through the working electrode to an analogue voltage signal, an A/D converter which converts the analogue signal to a digital signal, and a controller which operates the working voltage generating circuit to apply a first voltage to the working electrode when the test strip is inserted into the readout meter(t0), and to apply a second voltage to the working electrode for a fixed period of time after a period of time(t2) depending on the position of the recognition electrode detected by the recognition electrode detecting device when the sample is inserted(t1), then(t3) to apply a third voltage to the working electrode and measures the concentration of the analyte of interest depending on the position of the recognition electrode by reading the digital signal from the A/D converter after a fixed period of time(t4) from the applying point(t3) of the third voltage.

With this invention mentioned above, it is possible to operate the quantitative analysis on various blood components such as blood sugar, cholesterol, and even GOT, GPT, etc with one readout meter since the test strip can automatically make the readout meter recognize the analytes of interest without the button operation. Also, since the readout meter does not require additional sockets, manufacturing expenses are very low. In addition, it is possible to make a checkstrip easily with the recognition electrode and the resistance, and to measure the precise concentration of the analyte of interest from this.

### BRIEF DESCRIPTION OF THE INVENTION

FIG. 1 is a disassembled perspective view of a conventional electrochemical biosensor test strip.

FIG. 2 is a perspective view illustrating an assembled state of the test strip of FIG. 1.

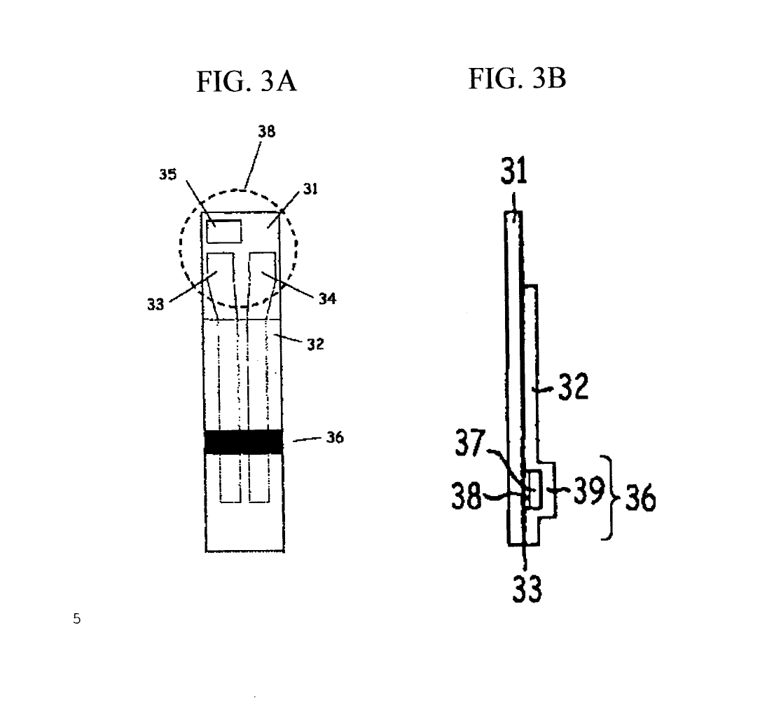

FIG. 3 shows an embodiment of the test strip of this invention, FIG. 3a is a plan view and FIG. 3b is a left-side view plan.

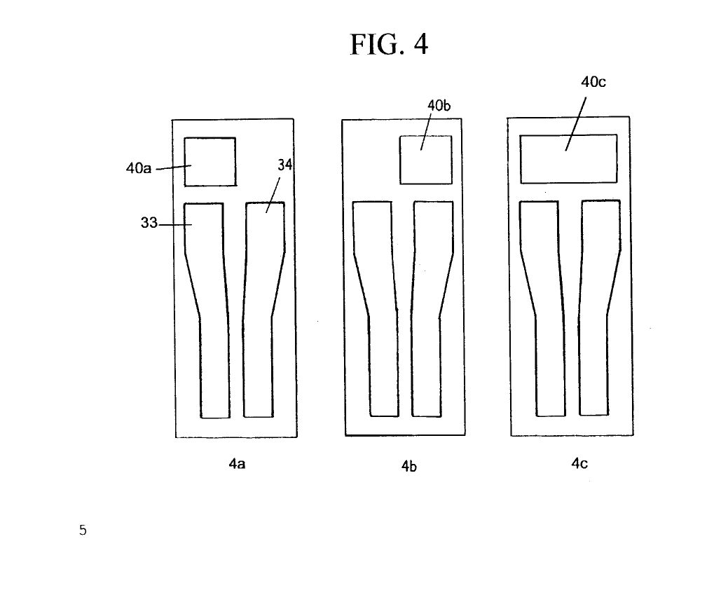

FIG. 4 is a plan view illustrating two kinds of test strip with different position of recognition electrode.

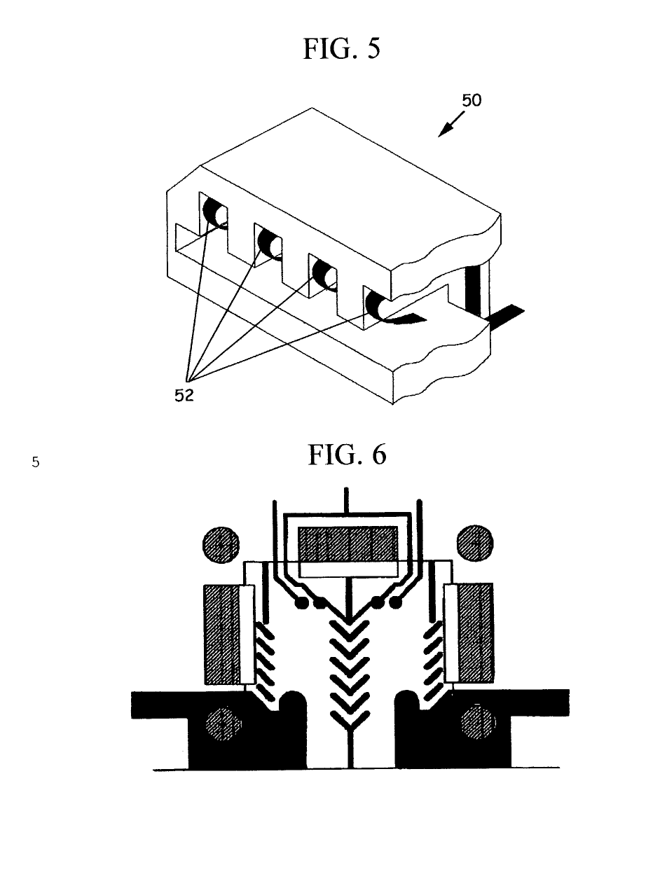

FIG. 5 is a perspective view of an electric connection device composing a socket device of the readout meter.

FIG. 6 is a plan view of an electric connection device composing a socket device of the readout meter.

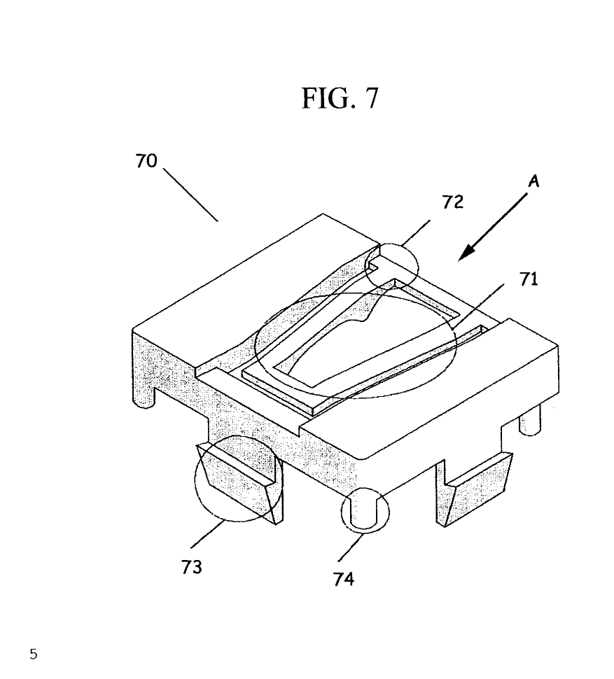

FIG. 7 is a perspective view of a compressing device composing a socket device of the readout meter.

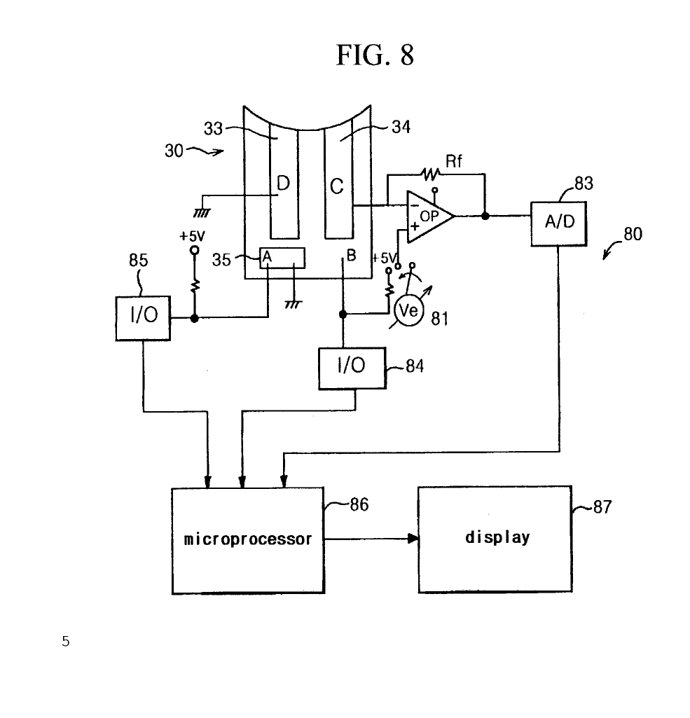

FIG. 8 is a circuit diagram of the readout meter of this invention.

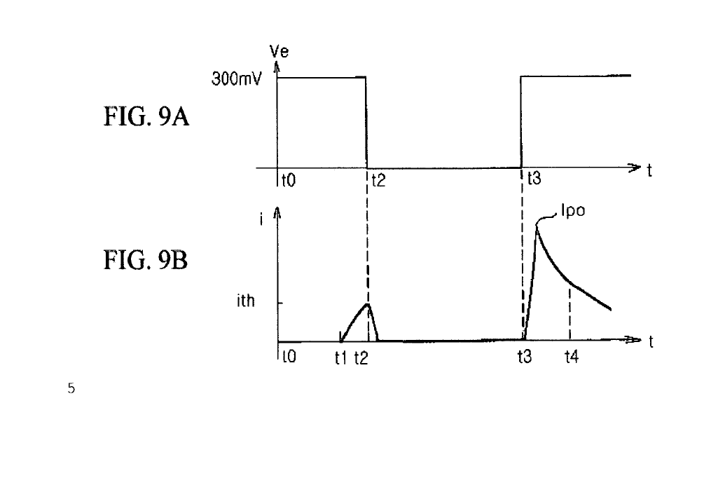

FIG. 9a shows a waveform of working voltage applied to a working electrode, and FIG. 9b shows a waveform of electric current flowing in the working electrode.

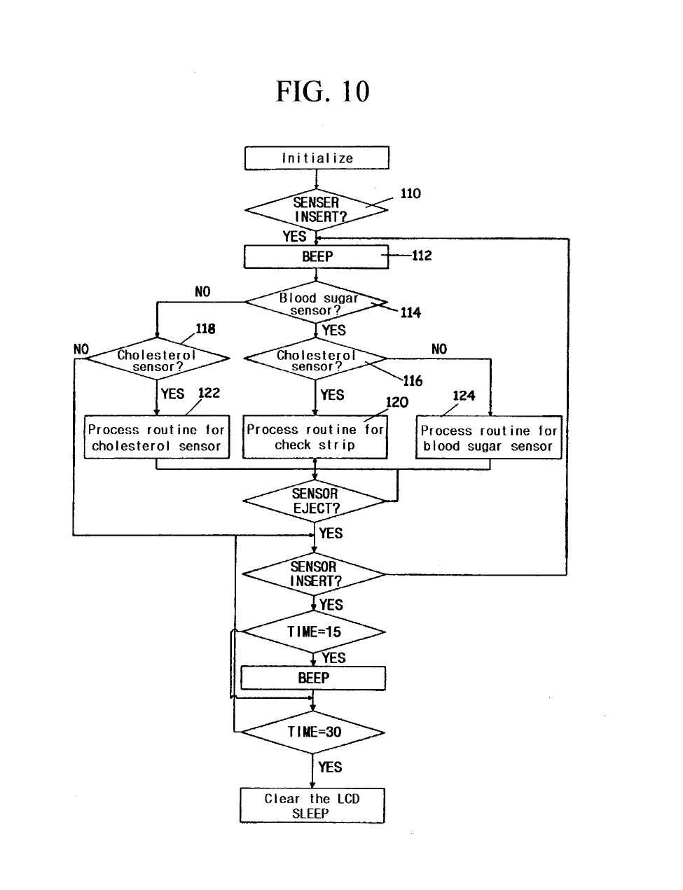

FIG. 10 is a flow chart illustrating the operations of the readout meter of this invention.

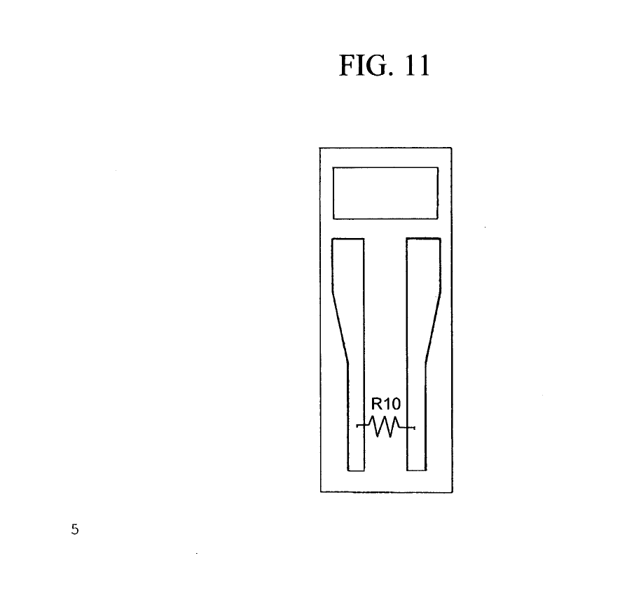

FIG. 11 is a plan view of correction test strip of this invention.

### BEST MODES FOR CARRYING OUT THE INVENTION

Hereinafter, the present invention is described specifically with reference to the embodiments illustrated in the drawings. But the embodiments below are to describe the invention in detail, not to limit the range of the invention.

FIG. 3 shows an embodiment of a test strip from this invention, FIG. 3a is a plan view, and FIG. 3b is a left-side view plan. Referring to FIG. 3a, 33 is a working electrode on which oxidation-reduction reaction between an analyte of interest and a reagent occurs, 34 is a reference electrode, and 35 indicates a recognition electrode.

As shown in FIG. 3a, the recognition electrode is established at a fixed position on the test strip which is determined depending on what material the reagent fixed across from the capillary space 36 to the working electrode and the reference electrode is to detect. When this test strip is inserted into the biosensor readout meter, the biosensor readout meter can identify what material is that the test strip is to analyze by discriminating the position of the recognition electrode on the test strip.

The materials of an insulating substrate 31 of this invention, can be of various insulators, but to mass-produce the electrochemical biosensor test strip of this invention simultaneously, it is preferable to have the flexibility suitable for roll processing and the strength for supporting. Preferably, high molecular compounds such as poly ester, poly carbonate, poly stylene, poly imide, poly vinyl chloride, poly ethylene, etc is recommended and especially poly ethylene telephthalate can be used.

It is preferable to form the electrode strips 33, 34, 35 on the insulating substrate 31 with sputtering using a shadow mask. That is, the electrode strips 33, 34, 35 is satisfactorily established on the insulating substrate 31 when removing the shadow mask after placing the shadow mask patterned after the electrode strip on the insulating substrate and operating the regular electric sputtering. In this case, a thin stainless metal plate is preferred for the shadow mask. Proper thickness of the shadow mask should be about 0.2 mm. If the electrode strip is established by sputtering using a shadow mask, very detailed electrode about 0.1 mm can be established easily without extra manufacturing process.

Preferred material for the electrode is noble metal such as palladium, platinum, gold, silver, etc. For noble metal is superb in electrochemical properties, such as excellent stability and reproducibility in the surface area of the electrode, and property of being difficult to oxidize, and so forth. Especially, gold is recommended for the material for the electrode. Gold is relatively cheap, and easy to process, and has the favorable adhesion with plastic and high-conductivity. So even if a gold electrode is established thinly in about 100 nm of thickness by sputtering, the electrode has a low electrical resistance, and adheres solidly to an insulating substrate such as plastic film or the like so that it is suitable as a disposable electrode.

The reagent 38 used here can include enzymes, redox mediator, hydrophile high molecular compounds, and surfactant. The enzymes varies depending on the materials to detect or to analyze. For example, glucose oxidase can be used in case of analyzing or detecting glucose. Used redox mediator includes potassium ferricyanide, imidazole osmium mediator which is described in U.S. Pat. No. 5,437,999, etc. Buffer, film formatant, and surfactant can be included as the reagent 38 besides enzyme and redox mediator. Buffer is to maintain the conditions such as pH at a regular level while the reagent 38 and the sample to analyze is reacting, hydrophile high molecular compound in need to fix the reagent on the electrode easily, and surfactant is to ease the process when the sample to analyze flows into the capillary space by capillary action. For instance, reagent to detect glucose can be established by compounding potassium ferricyanate, potassium phosfate buffer, cellulose, hydroxiletil cellulose, triton X-100 surfactant, sodium sucinate and glucose oxidase, and refer to U.S. Pat. No. 5,762,770 for the examples of usable enzymes and redox mediator and its specific manufacturing process.

Principle of measuring the concentration of the material to analyze or detect from the sample using the electrochemical biosensor test strip of this invention is as followed. For example, when glucose is to be detected and analyzed from the blood sample, glucose oxidase used as an enzyme, and potassium ferricyanide as redox mediator, glucose is oxidized and ferricyanide is deoxidized into ferrocyanide. At this time, glucose oxidase works as a catalyzer. When voltage is put on to both electrode after a certain reaction time by a power supply, electric current is generated by electron transition caused by reoxidization of the ferrocyanide. Voltage put on to the two electrodes should be less than 300 mV, and about 100 mV is used considering the properties of the mediator.

An electric current measured by the method above can be correlated to the concentration of the analyte from the sample by applying algorithm stored within the biosensor readout meter. Also, by integrating the current to a certain period of measurement from the electric current-measurement time related curve, the total amount of electric charge(this electric charge is proportional to the concentration of the analyte of interest) can be achieved during that period.

FIG. 4 illustrates examples of two kinds of electrochemical biosensor test strip which has different positions of the recognition electrode in accordance with this invention, FIG. 4a is a test strip for measuring blood sugar, FIG. 4b is a test strip for measuring cholesterol, and FIG. 4c is a correction test strip(hereinafter referred to “check strip”) for correcting the readout meter to change the electric current from the test strip into the precise concentration, by supplying the information of the test strip to the readout meter. Recognition electrodes 40a, 40b, 40c are established in different positions as illustrated in FIG. 4 to notify the readout meter of the fact that the different reagents are fixed onto the capillary space depending on the analytes of interest automatically without any manual button operation.

This position of the recognition electrode can be arranged two-dimensionally on the test strip. When the recognition electrode is arranged two-dimensionally, the recognition electrode with various informations of the position can be established easily on the limited test strip.

FIG. 5 is a perspective view illustrating a socket device of the conventional readout meter. As illustrated in FIG. 5, since a socket device 50 of the conventional readout meter has one-dimensional arrangement of a metal strip 52 in a widthwise direction of the test strip, the number of the electrodes on the test strip which such a socket device can permit, is limited. Also, it was hard to manufacture and expensive.

A socket device of the biosensor readout meter of this invention is composed of an electric connection device of which the connecting terminal is formed in PCB pattern, and a compressing device which electrically connects the electrode of the test strip to the connecting terminal of the electric connection device by compressing the test strip to the electric connection device.

FIG. 6 is a plan view illustrating PCB pattern of the electric connection device composing the socket device of the readout meter of this invention. Referring to FIG. 6, the connecting terminal is formed in pattern on PCB corresponding to the end portion of the working electrode, and the reference electrode on the test strip and the position of the recognition electrode when the test strip is fully inserted into the socket device of the readout meter.

Referring to FIG. 4 and FIG. 6 about the electrical connection between the test strip and the biosensor readout meter, when the test strip of FIG. 4 is inserted into the socket device of the biosensor readout meter of FIG. 6 which is composed of an electric connection device, the working electrode 33 on the test strip gets electrically connected to the working electrode connecting terminal 62 on the electric connection device 50. The reference electrode 34 is electrically connected to the reference electrode connecting terminal 64, the recognition electrode for indicating blood sugar 40a to the first recognition electrode connecting terminal 66, and the recognition electrode for indicating cholesterol 40b to the second recognition electrode connecting terminal 68. The recognition electrode connecting terminal can easily be established two-dimensionally onto PCB in FIG. 6. Therefore, for numerous recognition electrode connecting terminals can be established on the electric connection device of the socket device, quantitative analysis on various materials with only one readout meter is possible. Also, since the connecting terminal can be made two-dimensionally, process margin is large.

FIG. 7 is a perspective view illustrating the compressing device for compressing the test strip of FIG. 4 to the electric connection device of FIG. 6 to connect both electrically. The electric connection device of FIG. 6 is installed below the compressing device illustrated in FIG. 7. The compressed part 71 is lifted up when the test strip is inserted in the direction of A so that the connecting area 72 is forced in the twisted direction, then by this force, the compressed part 71 pushes the test strip to the electric connection device installed below. 73 is a fixed area in FIG. 7, which is inserted into a groove on the electric connection device 60, fixes the compressing device 70 to the electric connection device 60.

FIG. 8 is the circuit diagram of the electrochemical biosensor readout meter of this invention. When the test strip 30 as illustrated in FIG. 4a is inserted properly into the electric connection portion of the readout meter 80, the voltage of the contact point A where the recognition electrode 35 on the test strip 30 is connected drops from 5V to 0V. This change of the voltage is detected in I/O 85 and informed to the microprocessor 86, therefore the insertion of the test strip into the electric connection portion of the readout meter is recognized. Also, since I/O 85 maintains at 0V and I/O 84 at 5V, the microprocessor 86 can recognize that the inserted test strip is for measuring blood sugar. When the test strip of FIG. 4b is inserted, I/O 25 of the electric connection portion of the readout meter maintains at 5V and I/O 24 at 0V, so that the microprocessor automatically recognizes as a test strip for cholesterol, and when the test strip of FIG. 4c is inserted, the microprocessor automatically recognizes the test strip as a check strip since both I/O 24 and I/O 25 of the electric connection portion of the readout meter maintain at 0V. The check strip revises the readout meter to measure the concentration of the analyte more accurately by supplying the informations on the test strip to the readout meter.

When the test strip for measuring blood sugar as illustrated in FIG. 4a is inserted into the electric connection portion of the readout meter 80, the switch of the working voltage generator 81 is closed on the operational amplifier OP, and the working voltage generator 81 generates 300 mV. The generated voltage puts on 300 mV of working voltage between the reference electrode 33 and the working electrode 34 of the test strip due to the feedback of the operational amplifier OP.

From this point, wait until blood is inserted into the reaction part 36 of the test strip. When blood is inserted at t1 of FIG. 9b, electric charge is generated due to the chemical reactions between the blood and the reagent fixed in the reaction part, and the electric charge becomes electric current by the working voltage which is applied to the working electrode. This electric current is inputted into A/D converter 83 via resistance(Rf). The microprocessor 86 measures the amount of electric current by reading the changes in value of the A/D converter, and when the electric current is above a fixed value(t2), recognizes as blood is inserted. When the blood is not inserted, some electric current may flow in input terminal of the A/D 83 converter due to noise, even if there is no flowing electric current theoretically. Therefore, to prevent the malfunction caused by noise, the microprocessor recognizes as blood is inserted only when over a certain amount of electric current value is read on the A/D converter 83 as illustrated in FIG. 9b. Since the range of electric current is different depending on the analytes of interest, the critical electric current value(ith), which is used to detect whether blood is inserted, varies corresponding to the analytes. Since the biosensor readout meter of this invention can automatically distinguish which material the test strip is to analyze with the recognition electrode 35, it can apply a critical electric current value(ith) differently depending on the analytes by reading the values already stored inside the readout meter.

At the point(t2) the microprocessor 86 recognizes as blood is inserted, the voltage of working voltage generator 81 turns almost 0V. Here, electric charge is accumulated around the working electrode due to the chemical reactions between the blood and the reagent of the reaction part 36. After a certain reaction period, the voltage of working voltage generator 81 turns 300 mV at the point of t3. When 300 mV is put on as a working voltage as illustrated in FIG. 9a, the electric current flows through working electrode as in FIG. 9b, and after a certain period t4, measures the electric current flowing through the test strip 10. The microprocessor 86 is provided with ROM(not illustrated) which stores the relations between the electric current and the concentration of the analytes of interest. Therefore it is possible to measure the concentration of blood sugar from blood by reading the electric current at t4 point. If the test strip for cholesterol, illustrated in FIG. 4b, is used, the electric current of t4 point is related to the concentration of cholesterol in blood.

FIG. 10 is a flow chart indicating operation orders of the readout meter of this invention. When the power button is pressed, the readout meter confirms whether the test strip is inserted 110, blinking an icon indicating that to insert the test strip into the LCD. When the test strip is inserted, buzzer rings and the readout meter confirms whether the recognition electrode is established on the blood sugar indicating position and cholesterol indicating position on the test strip in order 112, 114, 116, 118. If the recognition electrode is established on both the blood sugar indicating position and cholesterol indicating position, executes the check strip process routine 120, when the recognition electrode is established only on cholesterol indicating position, executes cholesterol process routine 122, and when the recognition electrode is established only on blood sugar indicating position, executes blood sugar process routine 124. After the execution of process routine, the test strip is removed and the readout meter is automatically shut down after a while without insertion of any new test strip. When new test strip is inserted, buzzer rings again and the readout meter re-operates the step 112, 114, 116, 118 confirming the position of recognition electrode on the test strip.

Not only confirming whether the test strip is inserted, it is possible to include another step confirming whether the memory button of the readout meter is pressed, in step 110. In case the memory button is pressed, the values stored inside EEPROM of the readout meter is fetched.

If the test strip is not inserted for a certain time, alarm rings and automatically turns the power off. When the test strip slips out of the readout meter while measuring, re-operates from the step 110.

The execution of blood sugar process routine 124 is as followed. First, the readout meter indicates blood sugar on the LCD, and confirms whether the sample is inserted with blinking an icon. When the sample is inserted, waits some time, for instance 15 seconds, for the sample and the reagent to react. After 15 seconds, applies about 0.1V of voltage between the working electrode and the reference electrode on the test strip for a while, for instance 15 seconds, and measures the electric current flowing on the electrode of the test strip, changes it into the blood sugar value, stores the value in EEPROM and displays on LCD.

The execution of cholesterol process routine 112 is identical to the execution of blood sugar process routine 124, except that the corresponding relations between the cholesterol values and the electric current on the electrode of the test strip are different.

FIG. 11 is a diagram illustrating an embodiment of a check strip of this invention. In FIG. 11, 111 is a recognition electrode, 112 is a reference electrode, 113 is a working electrode, and 114 is a resistance to supply the readout meter of informations on the test strip. As mentioned above, When a check strip 110 is inserted into the readout meter as illustrated in FIG. 8, the inserted test strip is recognized as a check strip by the microprocessor 86 since the point A, B both turns to 0V. In a check strip 110, the reference electrode 112 and the working electrode 113 is connected to the resistance 114. This resistance 114 makes a certain electric current flow through the working electrode 113 when a working voltage is applied to the working electrode 113. The electric current makes the readout meter recognize the informations on the test strip since it is converted into voltage by the operational amplifier(OP), converted into digital voltage signal by the A/D converter 83 and then read by the microprocessor 86. The readout meter can measure the concentration of the analytes more accurately by using these informations.

1. (amended) An electrochemical biosensor test strip for measuring concentration of analyte electrochemically by being used with an electrochemical biosensor readout meter, comprising:
a first insulating substrate;
a plurality of electrodes formed on the first insulating substrate in a lengthwise direction;
a reagent for reacting with the analyte to generate a current corresponding to the concentration of the analyte, the reagent being fixed over the plurality of electrodes on the first insulating substrate; and
a recognition electrode formed on a predetermined position of the first insulating substrate according to use of the test strip, the recognition electrode being located on a part of the first insulating substrate inserted the readout meter, whereby the recognition electrode indicates the use of the test strip to the readout meter.

2. The electrochemical biosensor test strip as set forth in claim 1, further comprising a second insulating substrate above the first insulating substrate, and the first insulating substrate and the second insulating substrate forming a sample input entrance on the position of the first insulating substrate where the reagent is fixed.

3. The electrochemical biosensor test strip as set forth in claim 2, wherein the sample input entrance is formed of a capillary space.

4. The electrochemical biosensor test strip as set forth in claim 1, wherein the recognition electrode is arranged at a fixed position two-dimensionally on the first insulating substrate.

5. (amended) An electrochemical biosensor readout meter for measuring concentration of analyte electrochemically by being used with an electrochemical biosensor test strip, comprising;
a socket device which is electrically connected to electrodes of the test strip when the test strip is inserted to the readout meter, and generating a test strip insertion signal and an test strip type signal by detecting analyte information of the test strip;
an electric current measuring device for measuring value of electric current flowing through the electrodes of the test strip, the electric current measuring device being connected electrically with the socket device;
an analyzing device which analyzes concentration of the analyte according to the electric current value measured by the electric current measuring device and the test strip type signal generated by the socket device; and
an indicating device indicating the analyzed concentration of the analyte.

6. The electrochemical biosensor readout meter as set forth in claim 5, wherein the socket device comprises an electric connection device of which the connecting terminal is formed in PCB pattern, and a compressing device electrically connecting the electrode on the test strip and the connecting terminal on the electric connection device by compressing the test strip to the electric connection device.

7. (amended) An electrochemical biosensor system comprising an electrochemical biosensor test strip and a biosensor readout meter,
wherein the electrochemical biosensor test strip includes:
a first insulating substrate;
a plurality of electrodes formed on the first insulating substrate in a lengthwise direction;
a reagent for reacting with the analyte to generate a current corresponding to the concentration of the analyte, the reagent being fixed over the plurality of electrodes on the first insulating substrate; and
a recognition electrode formed on a predetermined position of the first insulating substrate according to use of the test strip, the recognition electrode being located on a part of the first insulating substrate inserted the readout meter, whereby the recognition electrode indicates the use of the test strip to the readout meter, and
the biosensor readout meter includes:
a socket device which is electrically connected to the electrodes of the test strip when the test strip is inserted to the readout meter, and generating a test strip insertion signal and an test strip tape signal by detecting the recognition electrode of the test strip;
an electric current measuring device for measuring value of electric current flowing through the electrodes of the test strip, the electric current measuring device being connected electrically with the socket device;
an analyzing device which analyzes concentration of the analyte according to the measured electric current value and the test strip type signal; and
an indicating device indicating the analyzed concentration of the analyte.

8. (cancelled)

9. (amended) A method for operating an electrochemical biosensor readout meter measuring concentration of analyte electrochemically by being used with an electrochemical biosensor test strip, comprising the steps of:
confirming whether the test strip is inserted into the readout meter when power button is pressed;
distinguishing position of recognition electrode formed on the test strip to determined use of the test strip; and
executing process routine corresponding to the use of the test strip determined by the position of the recognition electrode.

10. The method as set forth in claim 9, wherein the confirming step further comprises the step of turning the readout meter off when the test strip is not inserted for a certain period of time.

11. The method as set forth in claim 9, wherein the confirming step further comprises the steps of confirming whether the memory button of the readout meter is pressed, and indicating after reading the values stored inside the readout meter when the memory button is pressed.

12. The method as set forth in claim 9, further comprising the step of re-operating from the test strip confirming step when the test strip slips out of the readout meter.

13. The method as set forth in claim 9, wherein the process routine executing step comprises:
confirming whether the sample is inserted;
analyzing the concentration of the analyte of interest by measuring the electric current with applying a certain voltage to the electrode on the test strip after waiting a certain period of time for the sample and the reagent to react in case the sample is inserted; and
outputting the concentration value of the analyte.

14. A readout meter using the electrochemical biosensor test strip as set forth in claim 1, comprising:
a device recognizing the analyte of interest of the test strip by distinguishing the position of the recognition electrode;
a working voltage generating circuit applying a working voltage to the working electrode;
a voltage converting device converting the electric current flowing through the working electrode into an analogue voltage signal;
an A/D converter converting the analogue voltage signal from the voltage converting device into a digital voltage signal;
a controller which operates the working voltage generating circuit to apply a fixed working voltage to the working electrode when the test strip is inserted into the readout meter(t0), and not to apply any voltage for a fixed period time when the sample is inserted (t1) and the digital voltage signal from the A/D converter turns to a fixed critical voltage (t2) depending on the analyte of interest, and then (t3) re-operates the working voltage generating circuit to apply the working voltage to the working electrode, and measures the concentration of the analyte by distinguishing the digital voltage signal from the applying A/D converter after a fixed period of time from the applying point of working voltage (t3).

15. (amended) An electrochemical biosensor test strip for being used with an electrochemical biosensor readout meter, comprising:
a first insulating substrate;
two parallel electrodes formed on the first insulating substrate in a lengthwise direction;
a resistor connected between the two electrodes, having a predetermined resistance value for adjusting the readout meter; and
a recognition electrode indicating that the test strip is used for adjusting the readout meter by being formed on a predetermined position on the first insulating substrate.
